(19) United States
(12) Patent Application Publication
(10) Pub. No.: US 2025/0158879 A1
(43) Pub. Date: May 15, 2025

(54) CONFIGURATION INPUT APPARATUS, CONFIGURATION INPUT METHOD, AND CONFIGURATION INPUT PROGRAM

(71) Applicant: Nippon Telegraph and Telephone Corporation, Tokyo (JP)

(72) Inventors: Hiroki IWAHASHI, Musashino-shi, Tokyo (JP); Masato NISHIGUCHI, Musashino-shi, Tokyo (JP); Hiroki INOUE, Musashino-shi, Tokyo (JP); Toshiyuki KANAZAWA, Musashino-shi, Tokyo (JP)

(21) Appl. No.: 18/836,408

(22) PCT Filed: Feb. 17, 2022
(86) PCT No.: PCT/JP2022/006497

§ 371 Date: Aug. 7, 2024

(51) Int. Cl. H04L 41/0803; H04L 41/0853

(52) U.S. Cl. CPC H04L 41/0803; H04L 41/0856

(57) ABSTRACT

A centralized management server includes a corresponding unit, a determination unit, and a device control unit. The corresponding unit receives a request for inputting a configuration of a user to the communication device. Then, the corresponding unit integrates the plurality of parameters included in the received request into a parameter group. The determination unit determines a communication device accommodating the user. The device control unit decomposes the parameter group into the plurality of parameters and inputs the configuration of the user to the communication device determined by the determination unit based on the plurality of parameters.

### TECHNICAL FIELD

The present disclosure relates to a configuration input device, a configuration input method, and a configuration input program.

### BACKGROUND ART

Communication service providers provide various types of communication services. Examples of the communication services include an Internet connection service and a video distribution service. These communication services are provided in accordance with “user configurations” set in communication devices such as edge routers.

For convenience, the configuration is abbreviated to “Config”. For example, a user Config means a user configuration.

The user Config includes data such as a user identifier (ID) and a service used by a user. The user Config is set by a centralized management server.

The centralized management server manages resources of communication devices included in a network. For example, the resources of the communication device include a band, the number of filters that can be set in a communication device, and the number of sessions that can be established. Data related to the resources is collected in the centralized management server. The centralized management server selects a communication device accommodating a user according to available resources of each communication device. Then, the centralized management server sets a user Config in the selected communication device.

To facilitate modification, functions of the centralized management server are divided into “a function of generating a user Config” and “a function of inputting a command to a communication device”. Further, a template file is prepared for each scenario. Such a management system allows a communication service provider to easily handle a specification change of a command or a model change of a communication device.

### CITATION LIST

### Non Patent Literature

[NPL 1] Iwahashi and two others, “Proposal of Distributed Configuration of User Accommodation Flexibilization System in Edge Router” 2020 Institute of Electronics, Information and Communication Engineers Society Conference, B-6-1, September 2020
[NPL 2] Iwahashi and three others, “User Config Input to Edge Router Easily Modified by Ansible” 2021 Institute of Electronics, Information and Communication Engineers General Conference, B-6-67, March 2021

### SUMMARY OF INVENTION

### Technical Problem

However, in the foregoing techniques of the related arts, it is difficult to perform a configuration input that facilitates modification in a setting of the communication device in some cases.

Accordingly, the present disclosure proposes a configuration input device, a configuration input method, and a configuration input program capable of performing configuration input that facilitates modification in a setting of a communication device.

### Solution to Problem

In one aspect of the present disclosure, a configuration input device includes: a reception unit that receives a request for inputting a configuration of a user to a communication device; an integration unit that integrates a plurality of parameters included in the request received by the reception unit into a parameter group; a determination unit that determines a communication device accommodating the user; and an input unit that decomposes the parameter group into the plurality of parameters and inputs the configuration of the user to the communication device determined by the determination unit based on the plurality of parameters.

### Advantageous Effects of Invention

The configuration input device according to one or more embodiments of the present disclosure can perform a configuration input that facilitates modification in a setting of a communication device.

### BRIEF DESCRIPTION OF DRAWINGS

FIG. 1A is a diagram illustrating an example of processing for inputting a Config into a communication device.

FIG. 1B is a diagram illustrating an example of processing for inputting the Config into the communication device.

FIG. 1C is a diagram illustrating an example of processing for inputting the Config into the communication device.

FIG. 2 is a block diagram illustrating an example of an environment for a Config input.

FIG. 3 is a block diagram illustrating an example of a configuration of a centralized management server according to the present disclosure.

FIG. 4 is a block diagram illustrating an example of a configuration of a host system corresponding unit according to the present disclosure.

FIG. 5 is a block diagram illustrating an example of a configuration of a resource management/accommodation position determination unit according to the present disclosure.

FIG. 6A is a diagram illustrating an example of Config input processing according to the present disclosure.

FIG. 6B is a diagram illustrating an example of Config input processing according to the present disclosure.

FIG. 6C is a diagram illustrating an example of Config input processing according to the present disclosure.

FIG. 7A is a sequence diagram illustrating an example of processing for inputting the Config to the communication device.

FIG. 7B is a sequence diagram illustrating an example of processing for inputting the Config to the communication device.

FIG. 7C is a sequence diagram illustrating an example of processing for inputting the Config to the communication device.

FIG. 7D is a sequence diagram illustrating an example of processing for inputting the Config to the communication device.

FIG. 8 is a diagram illustrating a hardware configuration of a computer.

### DESCRIPTION OF EMBODIMENTS

A plurality of embodiments will be described in detail below with reference to the drawings. The present invention is not limited to the plurality of embodiments. A plurality of features of various embodiments may be combined in various ways under the conditions that these plurality of features are not contradictory to each other. The same constituents are denoted by the same reference numerals, and repeated description will be omitted.

The following description has nine sections: 1. Introduction, 2. Environment for Config Input, 3. Configuration of Centralized Management Server, 4. Config Input Processing according to Present Disclosure, 5. Sequence of Config Input Processing according to Present Disclosure, 6. Advantageous Effects, 7. Others, 8. Hardware Configuration, and 9. Conclusion of Embodiment.

### 1. First

Various kinds of communication services are provided through an Internet protocol (IP) Network. Communication devices such as edge routers are connected to the IP network. The communication device performs control required to provide a communication service to a user based on a Config of the user. The Config of the user is managed by a centralized management server connected to the IP network. The centralized management server inputs the Config of the user to the communication device.

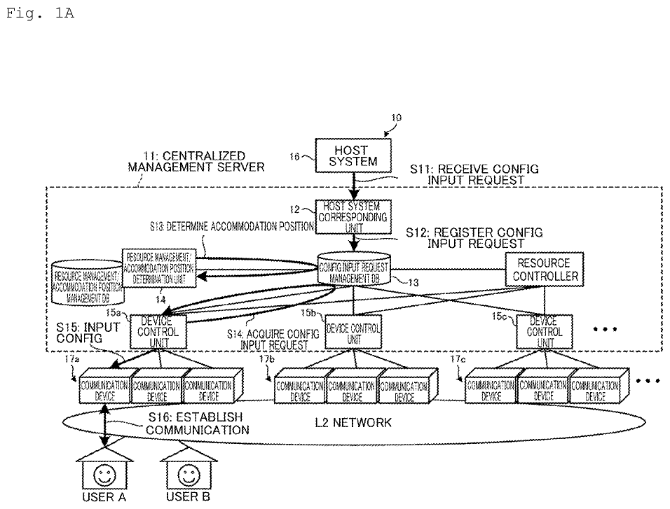

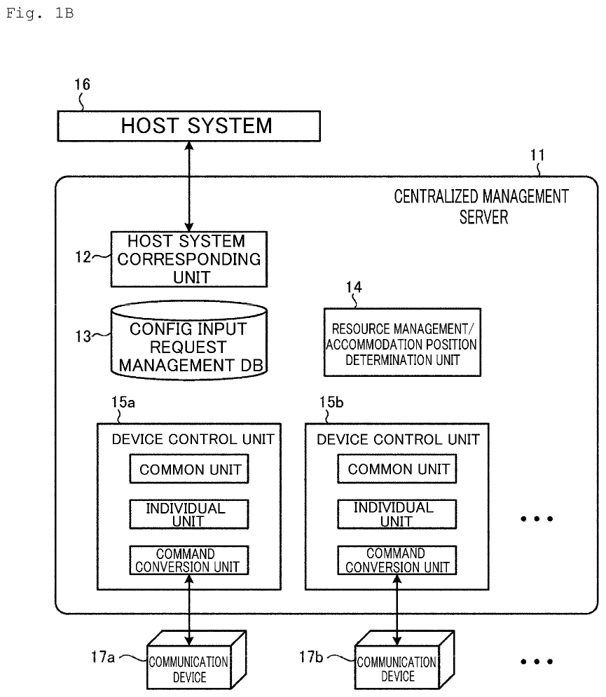

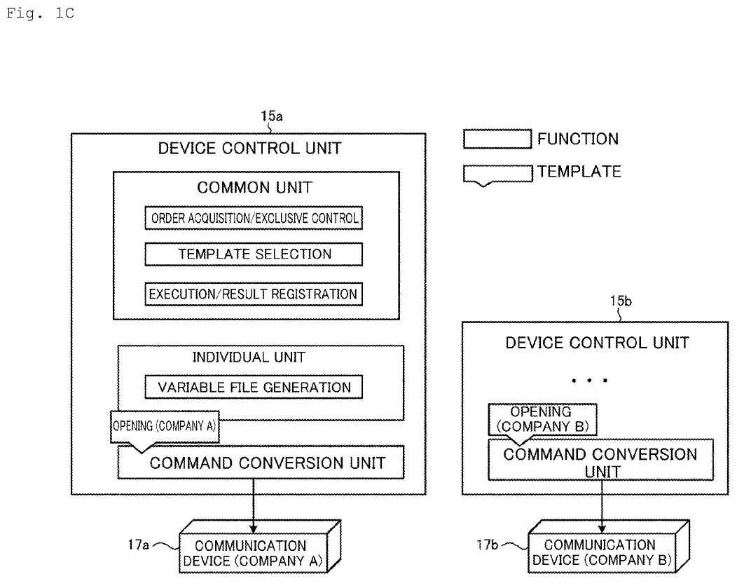

FIGS. 1A, 1B and 1C illustrate processing 10 which is an example of processing for inputting the Config to the communication device in a batch.

Referring to FIG. 1A, the processing 10 is performed by the centralized management server 11. The centralized management server 11 manages the number of available resources of the communication device. As illustrated in FIG. 1A, the centralized management server 11 includes a host system corresponding unit 12; a Config input request management database (DB) 13; a resource management/accommodation position determination unit 14; and a plurality of device control units 15. In addition, the centralized management server 11 includes functions such as a resource management/accommodation position management DB and a resource controller.

The processing 10 includes the following six steps.

In step S11, the centralized management server 11 receives a Config input request from the host system 16. The host system 16 may include an operator. The Config input request is, for example, a request for inputting a Config of a new user.

In step S12, the host system corresponding unit 12 registers the Config input request in the Config input request management DB 13.

In step S13, a resource management/accommodation position determination unit 14 determines an accommodation position of a user.

For example, the resource management/accommodation position determination unit 14 periodically monitors the Config input request management DB 13. When a new Config input request is registered in the Config input request management DB 13, the resource management/accommodation position determination unit 14 refers to the resource management/accommodation position management DB. Then, the resource management/accommodation position determination unit 14 confirms an available accommodation position.

After the available accommodation position is confirmed, the resource management/accommodation position determination unit 14 appropriately determines a communication device accommodating a user or a link aggregation (LAG) (or a physical port) according to the number of free resources of each communication device. The communication device is determined from an edge router group (edge group) with which the user can communicate. In the example of FIG. 1A, it is determined that a communication device 17a accommodates the user.

In step S14, the device control unit 15a acquires the Config input request from a Config input request management DB 13. In order to acquire a new Config input request, a device control unit 15a periodically monitors the Config input request management DB 13.

In step S15, the device control unit 15a inputs a Config to the communication device of a determined accommodation destination. The communication device of the determined accommodation destination is the communication device 17a.

In step S16, the device control unit 15a establishes communication. In the example of FIG. 1A, the communication of a user A is established on the device control unit 15a to which the Config is input.

Referring to FIG. 1B, the device control unit 15 of the centralized management server 11 includes a common unit, an individual unit, and a command conversion unit. Functions of the device control unit 15 are separated into three functions including (1) a function of performing common processing, (2) a function of performing individual processing for each order, and (3) a function of inputting a command.

Referring to FIG. 1C, the common unit has three functions of “order acquisition/exclusive control”, “template selection”, and “execution/result registration”. The individual unit has a function of “variable file generation”. The common unit, the individual unit, and the command conversion unit perform processing including the following six steps.

In the first step, the common unit acquires a Config input order from the host system 16. The common unit performs exclusive control of the Config input order.

In the second step, the common unit acquires scenario information of an order to be executed. The common unit calls an individual unit corresponding to the scenario information.

In the third step, the individual unit summarizes a variable group required for an input command in a variable file based on “the Config input order acquired by the common unit” and “the edge type of an input destination”. The individual unit transmits the variable file to the common unit.

In the fourth step, the common unit uses the variable file received from the individual unit as an argument and instructs the command conversion unit to generate and input a command.

In the fifth step, the command conversion unit generates an input command by combining a template with the variable file received from the common unit. Then, the command conversion unit inputs a command. The command conversion unit returns an input log to the common unit.

In the sixth step, the common unit stores a processing result of the Config input order in the Config input request management DB 13 based on the input log. The device control unit 15 ends the steps of the processing performed by these functional units.

As described above with reference to FIGS. 1A, 1B, and 1C, the centralized management server 11 can input the user Config to the communication device 17 in accordance with the number of available resources of the communication device 17 so that the user can be accommodated flexibly in the communication device 17.

However, a new service is added, the specification of a control target device is changed, or a new type of device is added in some cases. If such an event occurs, a parameter of the order from the host system 16 may be added or deleted.

The addition or deletion of the parameter of the order requires a change in parameter processing of an input interface (I/F) and a change in a DB structure. Since an application is modified with such changes, addition or deletion of the parameter of the order has a significant influence on the application. When a system which is operating is updated, the DB is required to be temporarily stopped. Accordingly, the addition or deletion of the parameter of the order also has a significant influence on a service.

To solve the above problems, the centralized management server according to one or a plurality of embodiments of the present disclosure performs one or a plurality of types of Config input processing to be described below.

### 2. Environment for Config Input

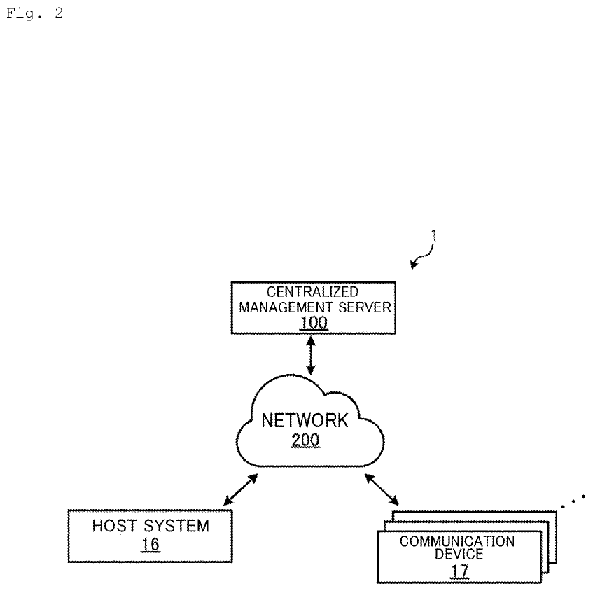

First, an environment for a Config input according to the present disclosure will be described with reference to FIG. 2.

FIG. 2 is a block diagram illustrating an environment 1 which is an example of an environment for an input. As illustrated in FIG. 2, the environment 1 includes a centralized management server 100, a network 200, a host system 16, and a communication device 17.

The centralized management server 100 is a device that performs one or a plurality of steps of Config input processing. The centralized management server 100 is an example of a configuration input device. The one or the plurality of steps of Config input processing includes processing for inputting the Config to the communication device 17. The Config input processing according to the present disclosure will be described in Section 4.

The centralized management server 100 is a data processing device such as a server. An example of the configuration of the centralized management server 100 will be described in Section 3.

The network 200 is, for example, a network such as a local area network (LAN), a wide area network (WAN), or the Internet. The network 200 connects the centralized management server 100, the host system 16, and the communication device 17.

### 3. Configuration of Centralized Management Server

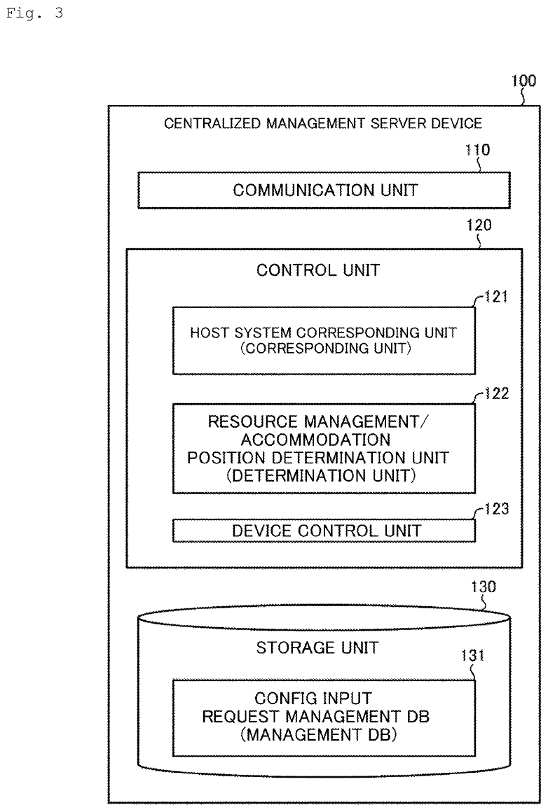

Next, an example of a configuration of the centralized management server 100 will be described with reference to FIG. 3.

FIG. 3 is a block diagram illustrating the centralized management server 100 which is an example of a configuration of a centralized management server according to the present disclosure. As illustrated in FIG. 3, the centralized management server 100 includes a communication unit 110, a control unit 120, and a storage unit 130. The centralized management server 100 may include an input unit (for example, a keyboard or a mouse) that receives an input from a manager of the centralized management server 100. The centralized management server 100 may include an output unit (for example, a liquid crystal display or an organic electroluminescence (EL) display) that displays information to the manager of the centralized management server 100.

### 3-1. Communication Unit 110

The communication unit 110 is implemented by, for example, a network interface card (NIC). The communication unit 110 is connected to the network 200 in wired or wireless manner. The communication unit 110 can transmit and receive information to and from the host system 16 and the communication device 17 via the network 200.

### 3-2. Control Unit 120

The control unit 120 is a controller. The control unit 120 uses a random access memory (RAM) as a working area, and is implemented by one or a plurality of processors (for example, a central processing unit (CPU) and a micro-processing unit (MPU)) that execute various programs stored in a storage device of the centralized management server 100. Further, the control unit 120 may be implemented by an integrated circuit such as an application specific integrated circuit (ASIC), a field-programmable gate array (FPGA), or a general purpose graphic processing unit (GPGPU).

For the sake of convenience, the “host system corresponding unit” is referred to simply as the “corresponding unit” for short below. The “resource management/accommodation position determination unit” is simply referred to as a “determination unit”, and the “Config input request management DB” is simply referred to as a “management DB”.

As illustrated in FIG. 3, the control unit 120 includes a corresponding unit 121, a determination unit 122, and a device control unit 123. One or a plurality of processors of the centralized management server 100 can implement each control unit by executing instructions stored in one or a plurality of memories of the centralized management server 100. Data processing performed by each control unit is exemplary, and each control unit (for example, the first corresponding unit 121) may perform data processing described in relation to another control unit (for example, the determination unit 122).

### 3-2-1. Corresponding Unit 121

The corresponding unit 121 is an example of the reception unit, a check unit, and an integration unit. The corresponding unit 121 receives a request for inputting the Config of the user to the communication device. This request is, for example, a Config input request to be described below. The corresponding unit 121 integrates a plurality of parameters included in a request into a parameter group.

### 3-2-2. Determination Unit 122

The determination unit 122 determines the communication device 17 accommodating a user based on information regarding an order of the host system 16 and information regarding the user. The information regarding the order is, for example, the plurality of above-described parameters. The determination unit 122 can decompose the parameter group integrated in the corresponding unit 121 into the plurality of parameters.

### 3-2-3. Device Control Unit 123

The device control unit 123 is an example of an input unit. The device control unit 123 decomposes the parameter group integrated in the corresponding unit 121 into the plurality of parameters. The device control unit 123 inputs the Config of the user to the communication device determined by the determination unit 122 based on the plurality of parameters.

### 3-3. Storage Unit 130

The storage unit 130 is implemented by, for example, a semiconductor memory element such as a RAM or a flash memory, or a storage device such as a hard disk or an optical disc. As illustrated in FIG. 3, the storage unit 130 includes a management DB 131.

### 3-3-1. Management DB 131

The management DB 131 is an example of a predetermined storage device. The management DB 131 stores a Config input request to be described below.

### 4. Config Input Processing According to Present Disclosure

In this section, an example of Config input processing according to the present disclosure will be described.

As described above with reference to FIGS. 1A, 1B, and 1C, the parameters of the order from the host system 16 are added or deleted in some cases. When functions of the corresponding unit (the host system corresponding unit) and the determination unit (the resource management/accommodation position determination unit) are built in as one batch, the manager of the centralized management server 100 has to correct and test all the functions even when parameters or logics are slightly changed.

Accordingly, in the centralized management server 100, the function of the corresponding unit 121 is separated into a common unit and an individual unit, as in the case of the device control unit 15 of the centralized management server 11. Similarly, the function of the determination unit 122 is separated into a common unit and an individual unit.

### 4-1. Function Separation of Common Unit and Individual Unit

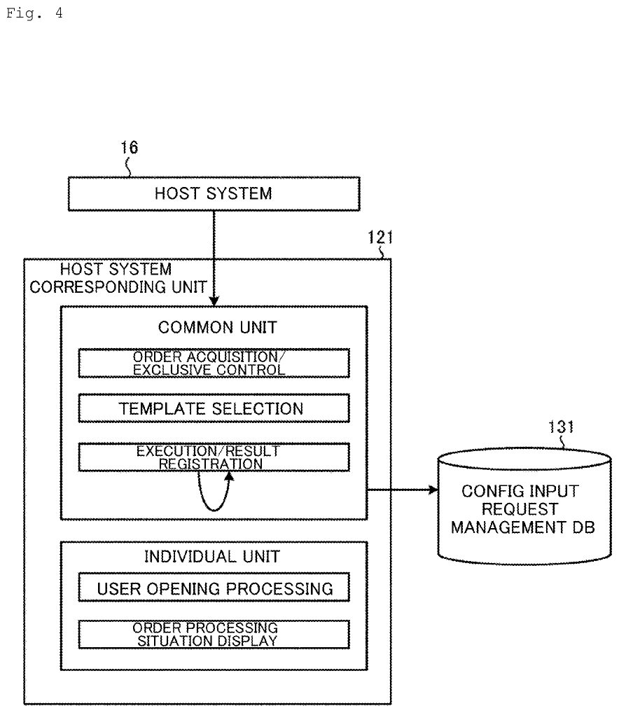

FIG. 4 is a block diagram illustrating an example of a configuration of a host system corresponding unit (corresponding unit 121) according to the present disclosure. As illustrated in FIG. 4, the common unit of the corresponding unit 121 has three functions of “order acquisition/exclusive control”, “template selection”, and “execution/result registration”. The common unit of the corresponding unit 121 may have functions similar to “order acquisition/exclusive control”, “template selection” and “execution/result registration” described above with reference to FIG. 1C. Here, repeated description will be omitted.

As illustrated in FIG. 4, the individual unit of the corresponding unit 121 has two functions of “user opening processing” and “order processing situation display”.

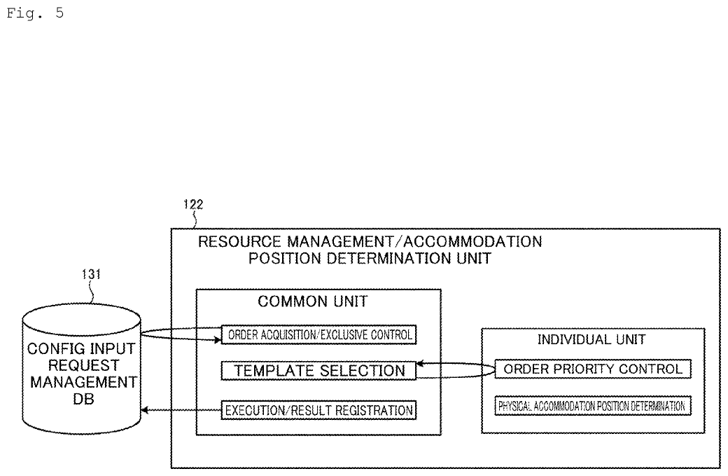

FIG. 5 is a block diagram illustrating an example of a configuration of a resource management/accommodation position determination unit (the determination unit 122) according to the present disclosure. As illustrated in FIG. 5, the common unit of the determination unit 122 has three functions of “order acquisition/exclusive control”, “template selection”, and “execution/result registration”. The common unit of the determination unit 122 can have functions similar to “order acquisition/exclusive control”, “template selection”, and “execution/result registration” described above with reference to FIG. 1C. Here, repeated description will be omitted.

As illustrated in FIG. 4, the individual unit of the determination unit 122 have two functions of “order priority control” and “physical accommodation position determination”.

Referring to FIGS. 4 and 5, the above-described common unit and individual unit perform processing including the following four steps.

In the first step, the common unit receives an order from the host system 16. Alternatively, the common unit acquires the order from the management DB 131. The common unit performs exclusive control of the order.

In the second step, the common unit acquires scenario information of the order to be performed. The common unit calls the individual unit corresponding to the scenario information.

In the third step, the individual unit individually processes the order for each order type. Then, the individual unit responds to a processing result of the order.

In the fourth step, the common unit stores the received processing result in the management DB 131. Then, the common unit and the individual unit end the processing.

### 4-2. Integration of Parameters and Decomposition of Parameter Group

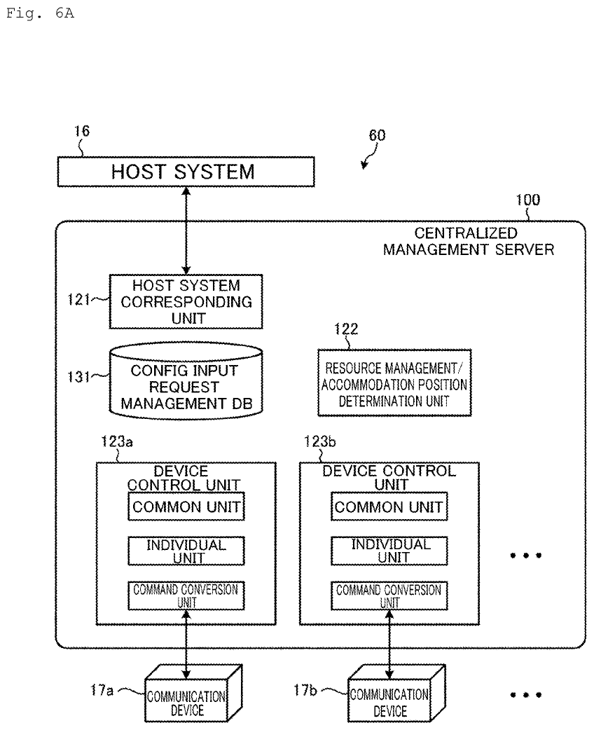

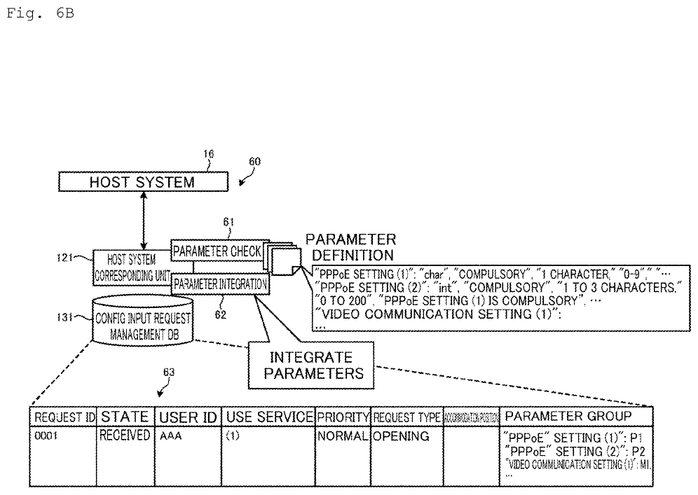

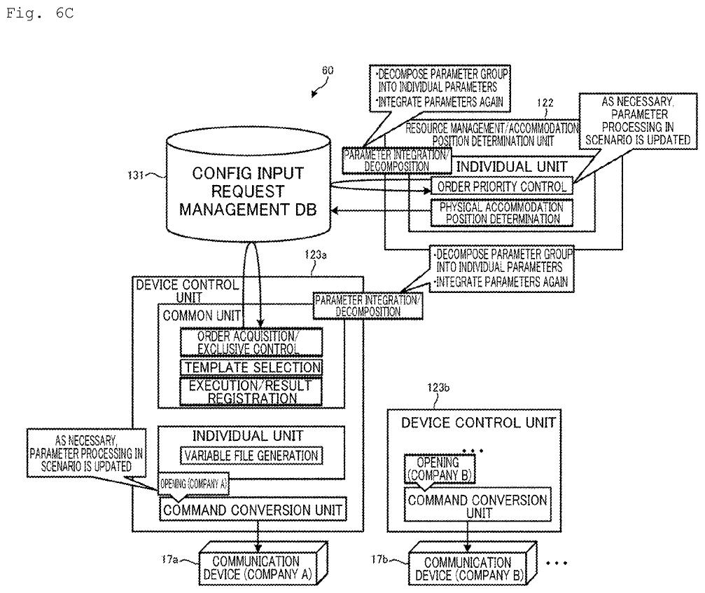

FIGS. 6A, 6B and 6C illustrate Config input processing 60 which is an example of Config input processing in a batch according to the present disclosure.

As illustrated in FIG. 6A, the device control unit 123 includes a common unit, an individual unit, and a command conversion unit. The device control unit 123 may have the functions similar to the “common unit”, the “individual unit” and the “command conversion unit” described above with reference to FIG. 1B. Here, repeated description will be omitted.

Referring to FIG. 6B, the corresponding unit 121 has a parameter check function 61 and a parameter integration function 62.

The parameter check function 61 is a function of the common unit of the corresponding unit 121. The common unit maintains an external file in which a type, a range, a condition, and the like of parameters for each scenario are defined. The external file is generated in advance by, for example, a maintainer or a developer. In the example of FIG. 6B, the common unit maintains an external definition file related to the parameters. The external definition file includes an item name such as a type, necessity or non-necessity, a character string length, a value range, and a correlation with other items. As illustrated in FIG. 6B, the parameter definition includes the following items: ““PPPoE setting (1)”: “char”, “compulsory”, 1 character”, “0-9”, “ ”, . . . “PPPoE setting (2)”: “int”, “compulsory”, “1 to 3 characters”, “0-200”, “PPPoE setting (1) is compulsory”, . . . “video communication setting (1)”: . . . ”.

For example, when the common unit receives a request from the host system 16, the common unit reads an external definition file corresponding to the request and checks each parameter included in the request. If there is no problem in the parameters, the common unit performs the parameter integration function 62 to be described below. If there is a problem in the parameters, the common unit may return an error. Alternatively, the common unit may perform processing according to the scenario information of the request.

The parameter integration function 62 is a function of the common unit of the corresponding unit 121. The common unit converts the parameters in JavaScript (registered trademark) Object Notation (JSON) format. Then, the common unit integrates all the converted parameters into a parameter group. The common unit stores the parameter group in one DB column. In the example of FIG. 6B, the common unit stores a Config input request 63 in the management DB 131. As illustrated in FIG. 6B, the Config input request 63 includes data such as a request ID, a state, a user ID, a use service, priority, a request type, an accommodation position, and a parameter group.

Referring to FIG. 6C, the determination unit 122 and the device control unit 123 have the function of “parameter integration and decomposition”. The function of the “parameter integration and solution” is a function of the common unit of the determination unit 122 and the device control unit 123. The common unit acquires the integrated parameter group from the management DB 131. The common unit decomposes the parameter group into individual parameters. When the common unit updates the acquired parameters, the common unit integrates the acquired parameters into a parameter group again. The common unit registers the parameter group again in the management DB 131.

The command conversion unit of the device control unit 123 can update parameter processing in the scenario as necessary. The individual unit (the function of “order priority control”) of the determination unit 122 can update the parameter processing in the scenario as necessary.

### 5. Sequence Diagram of Config Input Processing

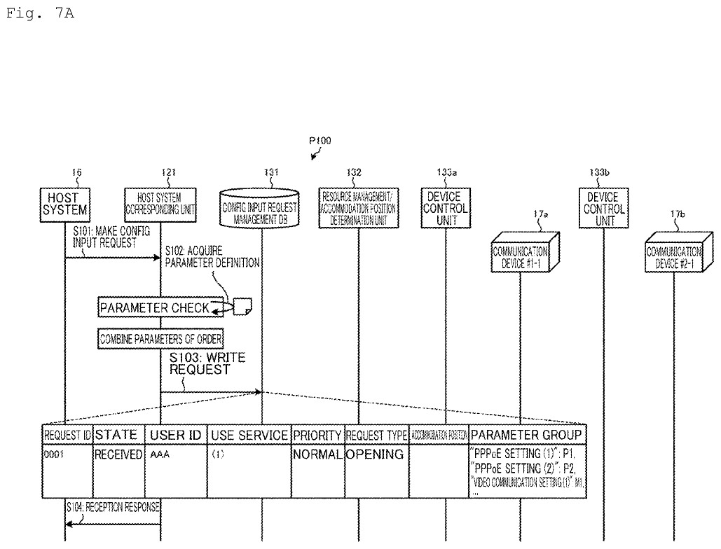

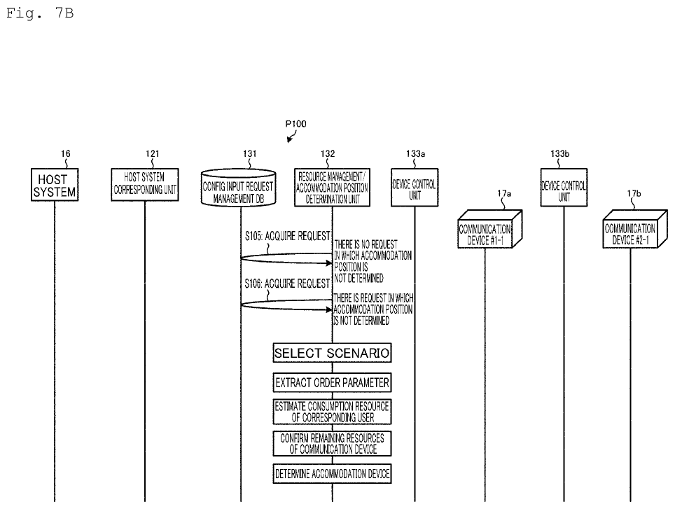

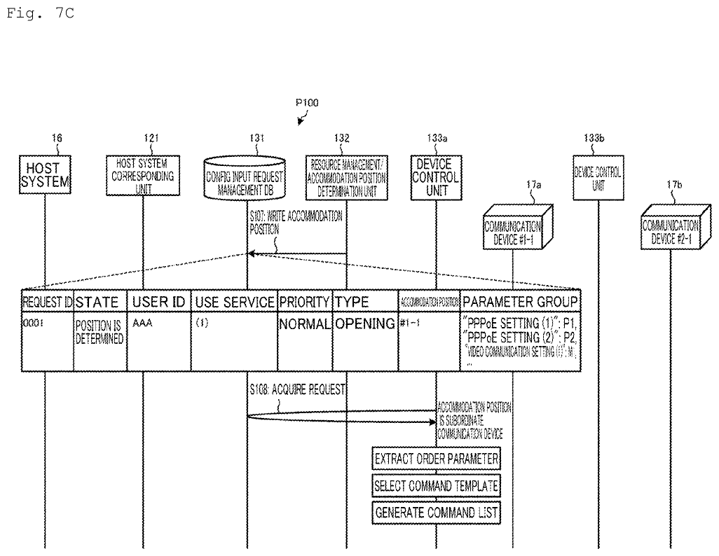

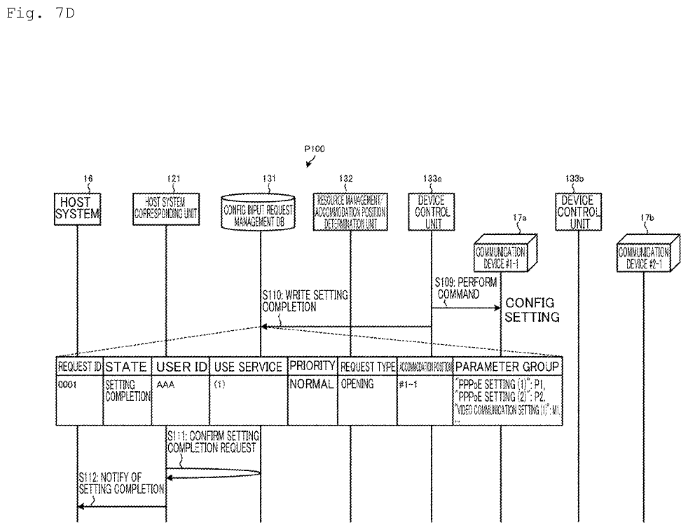

Next, a sequence diagram of an example of the Config input processing according to the present disclosure will be described with reference to FIGS. 7A, 7B, 7C, and 7D. The example of the Config input processing includes processing for inputting a Config to the communication device 17. The processing for inputting the Config to the communication device 17 is performed by, for example, the centralized management server 100 in FIG. 2.

FIGS. 7A, 7B, 7C and 7D are sequence diagrams illustrating processing P100 which is an example of processing for inputting the Config to the communication device in a batch.

Referring to FIG. 7A, in step S101, the corresponding unit 121 receives a Config input request from the host system 16.

In step S102, the corresponding unit 121 acquires the parameter definition from the management DB 131. The corresponding unit 121 performs “parameter check” and “order parameter combination” in response to the Config input request based on the parameter definition.

In step S103, the corresponding unit 121 writes the Config input request in the management DB 131. As illustrated in FIG. 7A, the Config input request includes data such as a request ID, a state, a user ID, a use service, priority, a request type, an accommodation position, and a parameter group. The accommodation position is empty. That is, the communication device 17 accommodating the user has not yet been determined.

In step S104, the corresponding unit 121 transmits a reception response to the host system 16.

Referring to FIG. 7B, in step S105, the determination unit 132 attempts to acquire a Config input request from the management DB 131. For example, the determination unit 132 confirms whether there is a Config input request in which an accommodation position has not been determined.

In step S106, there is a Config input request in which the accommodation position has not been determined, and the determination unit 132 acquires the Config input request. Then, the determination unit 132 executes “scenario selection”, “estimation of consumption resources of a corresponding user”, “confirmation of remaining resources of the communication device 17”, and “determination of the accommodation device”. If necessary, the determination unit 132 performs “order parameter extraction”.

Referring to FIG. 7C, in step S107, the determination unit 132 writes the determined accommodation position in the management DB 131. As illustrated in FIG. 7C, “#1-1” is written at the “accommodation position” of the Config input request. “#1-1” is an identifier corresponding to the communication device 17a.

In step S108, the device control unit 133a acquires a Config input request in which an accommodation position is a subordinate communication device from the management DB 131. The communication device 17a is subordinate to the device control unit 133a. Then, the device control unit 133a performs “order parameter extraction”, “command template selection”, and “command list generation”.

Referring to FIG. 7D, in step S109, the device control unit 133a performs a command and sets a Config in the communication device 17a.

In step S110, the device control unit 133a writes setting completion in the management DB 131. As illustrated in FIG. 7D, the “setting completion” is written in the “state” of the Config input request.

In step S111, the corresponding unit 121 confirms a setting completion request in the management DB 131.

In step S112, the corresponding unit 121 transmits a setting completion notification to the host system 16.

### 6. Advantageous Effects

As described above with reference to FIGS. 4 and 5, the functions of the corresponding unit 121 and the determination unit 122 are separated into the common unit and the individual unit.

As described above with reference to FIG. 6B, the common unit of the corresponding unit 121 has the function of parameter check. The common unit maintains the parameter definition as an external file. The parameter definition is, for example, a type, a range or a condition of the parameters for each request scenario from the host system 16.

The common unit of the corresponding unit 121 has the function of parameter integration. The common unit converts some of the parameters of the request received from the host system 16 in a JSON format. Then, the common unit integrates the converted parameters into a parameter group. The common unit stores the parameter group in one DB column.

The integrated parameters are, for example, parameters which are not a search key on the DB. Such parameters are a main integration target.

As described above with reference to FIG. 6C, the common unit of the determination unit 122 and the device control unit 123 has the function of parameter integration and decomposition. The common unit acquires information on the order from the DB. Then, the common unit decomposes the parameter group integrated in one column into individual parameters. When the common unit rewrites a value of the parameter group based on the acquired information regarding the order, the common unit integrates the decomposed parameters again into the parameter group. The common unit registers the parameter group again in the DB.

In the centralized management server 100, each function unit is divided into the common unit performing common processing and the individual unit performing individual processing for each order. Accordingly, the centralized management server 100 can minimize an influence when the application is modified or the specification of a control object device is changed.

Even when the parameters of the order from the host system 16 are added or deleted, the centralized management server 100 may not change the application or the DB column. Accordingly, the centralized management server 100 can reduce a development cost.

When the definition file is in a form readable by a person, an operator can easily edit the definition file. Thus, the development cost can be reduced.

The processing of a new parameter can be executed without modifying the application by editing the scenario file maintained by each function unit. Since the application is not changed, an update operation may be performed merely by replacing the definition file or the scenario file. Thus, the centralized management server 100 can shorten a job stop time in file update and reduce a work operation.

### 7. Others

Some of the types of processing described above as the automatically performed processing may be performed manually. Alternatively, all or some of the types of processing described above as the performed manually processing may be performed automatically according to known methods. Further, information including the procedures of the processing, the specific names, the various types of data and parameters described in the specification and drawings can be changed arbitrarily unless otherwise mentioned. For example, various types of information illustrated in each drawing is not limited to the information illustrated in the drawings.

The constituents of the illustrated devices conceptually show the functions of the device. The components are not necessarily physically configured as illustrated in the drawings. In other words, the specific forms of the distributed devices or the integrated device are not limited to the forms of the system and devices illustrated in the drawings. All or some of the devices may be functionally or physically distributed or integrated depending on various loads and usage situations.

### 8. Hardware Configuration

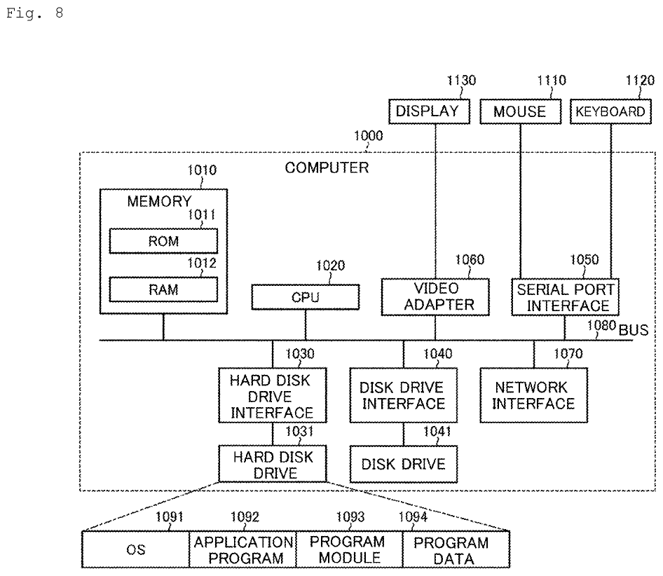

FIG. 8 is a diagram showing a computer 1000 which is an example of a hardware configuration of a computer. The system and methods described in the specification are implemented by, for example, the computer 1000 illustrated in FIG. 8.

FIG. 8 is a diagram illustrating an example of a computer in which the centralized management server 100 is implemented by executing a program. The computer 1000 includes, for example, a memory 1010 and a CPU 1020. The computer 1000 also includes a hard disk drive interface 1030, a disk drive interface 1040, a serial port interface 1050, a video adapter 1060, and a network interface 1070. These units are connected to one another via a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1031. The disk drive interface 1040 is connected to the disk drive 1041. For example, a detachable storage medium such as a magnetic disk or an optical disc is inserted into the disk drive 1041. The serial port interface 1050 is connected to, for example, a mouse 1110 and a keyboard 1120. The video adapter 1060 is connected to, for example, a display 1130.

The hard disk drive 1031 stores, for example, an OS 1091, an application program 1092, a program module 1093, and program data 1094. That is, a program that defines each processing of the management server 100 is implemented as the program module 1093 on which codes executable by the computer 1000 are described. The program module 1093 is stored in, for example, the hard disk drive 1031. For example, the program module 1093 performing the same processing as the functional structure of the centralized management server 100 is stored in the hard disk drive 1031. The hard disk drive 1031 may be replaced with a solid state drive (SSD).

The hard disk drive 1031 can store a configuration input program for Config input processing. In addition, the configuration input program may be generated as a program product. The program product executes one or a plurality of methods, as described above, when the program product is executed.

Setting data used in the processing of the above-described embodiments is stored as the program data 1094, for example, in the memory 1010 or the hard disk drive 1031. The CPU 1020 reads the program module 1093 or the program data 1094 stored in the memory 1010 or the hard disk drive 1031 to the RAM 1012 and executes the program module 1093 or the program data 1094 as necessary.

The program module 1093 or the program data 1094 is not necessarily stored in the hard disk drive 1031, and may be stored in, for example, a detachable storage medium and may be read by the CPU 1020 via the disk drive 1041 or the like. Alternatively, the program module 1093 and the program data 1094 may be stored in another computer connected via a network (LAN, WAN, or the like). The program module 1093 and the program data 1094 may be read by the CPU 1020 from another computer via the network interface 1070.

### 9. Conclusion of Embodiment

As described above, the centralized management server 100 according to the present disclosure includes the corresponding unit 121, the determination unit 122, and the device control unit 123. In at least one embodiment, the corresponding unit 121 receives a request for inputting the configuration of the user to the communication device. In at least one embodiment, the corresponding unit 121 integrates a plurality of parameters included in the received request into a parameter group. In at least one embodiment, the determination unit 122 determines a communication device accommodating a user. In at least one embodiment, the device control unit 123 decomposes the parameter group into the plurality of parameters and inputs the configuration of the user to the communication device determined by the determination unit 122 based on the plurality of parameters.

In several embodiments, the corresponding unit 121 associates the parameter group with accommodation data indicating whether the communication device accommodating the user is determined, and stores the parameter group associated with the accommodation data in a predetermined storage device.

In several embodiments, a determination unit 122 determines whether a communication device accommodating the user is determined based on the accommodation data stored in the predetermined storage device, determines a communication device accommodating the user when the communication device accommodating the user is not determined, and updates the accommodation data so that the accommodation data indicates the determined communication device.

In several embodiments, the device control unit 123 identifies the communication device determined by the determination unit 122 based on the accommodation data stored in the predetermined storage device, acquires the parameter group associated with the accommodation data indicating the identified communication device from the predetermined storage device, decomposes the acquired parameter group into the plurality of parameters, and inputs the configuration of the user to the identified communication device based on the plurality of parameters.

In several embodiments, the corresponding unit 121 acquires a definition file including definitions of the plurality of parameters included in the received request and checks the plurality of parameters based on the acquired definition file.

In several embodiments, the determination unit 122 determines a communication device accommodating the user among a plurality of predetermined communication devices based on at least one of resources consumed by the user or remaining resources of the plurality of predetermined communication devices.

While various embodiments have been described in detail in the specification with reference to the drawings, these embodiments are exemplary and are not intended to limit the present invention to these embodiments. The features described in the specification can be implemented according to various methods, including various modifications and improvements based on the knowledge of those skilled in the art.

Further, the above-described “units (modules and the suffix es-er and -or)” can be read as units, means, circuits, or the like. For example, the communication module, the control module, and the storage module can be read as a communication unit, a control unit, and a storage unit.

### REFERENCE SIGNS LIST

1 Environment
16 Host system
17 Communication device
100 Centralized management server
110 Communication unit
120 Control unit
121 Corresponding unit
122 Determination unit
123 Device control unit
130: Storage unit
131 Management DB
200 Network

1. A configuration input device comprising:
a reception unit, including one or more processors, configured to receive a request for inputting a configuration of a user to a communication device;
an integration unit, including one or more processors, configured to integrate a plurality of parameters included in the request received by the reception unit into a parameter group;
a determination unit, including one or more processors, configured to determine a communication device accommodating the user; and
an input unit, including one or more processors, configured to decompose the parameter group into the plurality of parameters and inputs the configuration of the user to the communication device determined by the determination unit based on the plurality of parameters.

2. The configuration input device according to claim 1, wherein the integration unit is configured to associate the parameter group with accommodation data indicating whether the communication device accommodating the user is determined, and store the parameter group associated with the accommodation data in a predetermined storage device.

3. The configuration input device according to claim 2, wherein the determination unit is configured to determine whether a communication device accommodating the user is determined based on the accommodation data stored in the predetermined storage device, determine a communication device accommodating the user when the communication device accommodating the user is not determined, and update the accommodation data so that the accommodation data indicates the determined communication device.

4. The configuration input device according to claim 3, wherein the input unit is configured to identify the communication device determined by the determination unit based on the accommodation data stored in the predetermined storage device, acquire the parameter group associated with the accommodation data indicating the identified communication device from the predetermined storage device, decompose the acquired parameter group into the plurality of parameters, and input the configuration of the user to the identified communication device based on the plurality of parameters.

5. The configuration input device according to claim 1, further comprising a check unit, including one or more processors, configured to acquire a definition file including definitions of the plurality of parameters included in the request received by the reception unit and checks the plurality of parameters based on the acquired definition file.

6. The configuration input device according to claim 1, wherein the determination unit is configured to determine a communication device accommodating the user among a plurality of predetermined communication devices based on at least one of resources consumed by the user or remaining resources of the plurality of predetermined communication devices.

7. A configuration input method executed by a computer, the method including:
receiving a request for inputting a configuration of a user to a communication device;
integrating a plurality of parameters included in the request received in the reception step into a parameter group;
determining a communication device accommodating the user; and
decomposing the parameter group into the plurality of parameters and inputting the configuration of the user to the communication device determined in the determination step based on the plurality of parameters.

8. A non-transitory computer-readable storage medium storing a configuration input program causing a computer to perform operations of a configuration input method, the operations comprising:
receiving a request for inputting a configuration of a user to a communication device;
integrating a plurality of parameters included in the request received in the reception step into a parameter group;
determining a communication device accommodating the user; and
decomposing the parameter group into the plurality of parameters and inputting the configuration of the user to the communication device determined in the determination step based on the plurality of parameters.

9. The configuration input method according to claim 7, wherein integrating a plurality of parameters comprises:
associating the parameter group with accommodation data indicating whether the communication device accommodating the user is determined, and storing the parameter group associated with the accommodation data in a predetermined storage device.

10. The configuration input method according to claim 9, wherein determining a communication device accommodating the user comprises:
determining whether a communication device accommodating the user is determined based on the accommodation data stored in the predetermined storage device, determining a communication device accommodating the user when the communication device accommodating the user is not determined, and updating the accommodation data so that the accommodation data indicates the determined communication device.

11. The configuration input method according to claim 10, wherein decomposing the parameter group into the plurality of parameters comprises:
identifying the communication device determined by the determination unit based on the accommodation data stored in the predetermined storage device, acquiring the parameter group associated with the accommodation data indicating the identified communication device from the predetermined storage device, decomposing the acquired parameter group into the plurality of parameters, and inputting the configuration of the user to the identified communication device based on the plurality of parameters.

12. The configuration input method according to claim 7, further comprising acquiring a definition file including definitions of the plurality of parameters included in the request received by the reception unit and checks the plurality of parameters based on the acquired definition file.

13. The configuration input method according to claim 7, wherein determining a communication device accommodating the user comprises:
determining a communication device accommodating the user among a plurality of predetermined communication devices based on at least one of resources consumed by the user or remaining resources of the plurality of predetermined communication devices.

14. The non-transitory computer-readable storage medium according to claim 8, wherein integrating a plurality of parameters comprises:
associating the parameter group with accommodation data indicating whether the communication device accommodating the user is determined, and storing the parameter group associated with the accommodation data in a predetermined storage device.

15. The non-transitory computer-readable storage medium according to claim 14, wherein determining a communication device accommodating the user comprises:
determining whether a communication device accommodating the user based on the accommodation data stored in the predetermined storage device, determining a communication device accommodating the user when the communication device accommodating the user is not determined, and updating the accommodation data so that the accommodation data indicates the determined communication device.

16. The non-transitory computer-readable storage medium according to claim 15, wherein decomposing the parameter group into the plurality of parameters comprises:
identifying the communication device determined by the determination unit based on the accommodation data stored in the predetermined storage device, acquiring the parameter group associated with the accommodation data indicating the identified communication device from the predetermined storage device, decomposing the acquired parameter group into the plurality of parameters, and inputting the configuration of the user to the identified communication device based on the plurality of parameters.

17. The non-transitory computer-readable storage medium according to claim 8, wherein the operations further comprise acquiring a definition file including definitions of the plurality of parameters included in the request received by the reception unit and checks the plurality of parameters based on the acquired definition file.

18. The non-transitory computer-readable storage medium according to claim 8, wherein determining a communication device accommodating the user comprises:
determining a communication device accommodating the user among a plurality of predetermined communication devices based on at least one of resources consumed by the user or remaining resources of the plurality of predetermined communication devices.
